(19) United States
(12) Patent Application Publication
(10) Pub. No.: US 2025/0170568 A1
(43) Pub. Date: May 29, 2025

(54) PIPETTE TIP FOR AND METHOD OF AUTOMATICALLY MAINTAINING PIPETTE TIP DEPTH IN A FLUID DURING A FLUID TRANSFER OPERATION

(71) Applicant: Formulatrix International Holding Ltd., Dubai (AE)

(72) Inventors: Sydney WHITE, Newburyport, MA (US); Rasmus LINDBLOM, Bedford, MA (US)

(73) Assignee: Formulatrix International Holding Ltd., Dubai (AE)

(21) Appl. No.: 19/036,674

(22) Filed: Jan. 24, 2025

Related U.S. Application Data
(63) Continuation-in-part of application No. 18/379,497, filed on Oct. 12, 2023.
Application No. 18/379,497 is a division of application No. 16/958,999, filed on Jun. 29, 2020, now Pat. No. 11,819,840.
(60) Provisional application No. 62/611,161, filed on Dec. 28, 2017.

(51) Int. Cl. B01L 3/02; G01N 35/10

(52) U.S. Cl. CPC B01L 3/0279; G01N 35/1016; B01L 2200/143; B01L 2300/0645; G01N 2035/1025

(57) ABSTRACT

The present invention discloses a pipette tip comprising a molded body made from an electrically insulating material, with an outer surface, an inner surface, and a translucent or transparent feature allowing visibility through both surfaces. The pipette tip further includes at least one impedance or capacitance electrode made from an electrically conductive material, positioned on the outer surface away from the translucent or transparent feature. Each electrode is electrically isolated on the outer surface, ensuring accurate and reliable measurements during liquid handling operations. This innovative design provides enhanced visibility and precise electrical measurements, making the pipette tip ideal for various laboratory applications.

### CROSS-REFERENCE TO RELATED APPLICATIONS

This application is a continuation-in-part of and claims priority to U.S. patent application Ser. No. 18/379,497, filed on Oct. 12, 2023, which is a divisional application of and claims priority to U.S. application Ser. No. 16/958,999, with U.S. Pat. No. 11,819,840, filed on Jun. 29, 2020, which is a 35 U.S.C. § 371 U.S. national phase entry of International Application No. PCT/US2018/066714 filed Dec. 20, 2018, which is related to and claims priority under 35 U.S.C. § 119(e) to U.S. Provisional Patent Application No. 62/611,161, entitled “Pipette Tip for and Method of Automatically Maintaining Pipette Tip Depth in a Fluid During a Fluid Transfer Operation,” filed on Dec. 28, 2017; the entire disclosures of which are incorporated herein by reference.

### FIELD

This disclosure relates to pipette tips allowing for impedance and/or capacitance measurements, and allowing for visual verification of function, and more particularly, to systems and methods for using the pipette tips and to the synergistic benefits described herein.

### BACKGROUND

Pipette tips, having electrically conductive strips or areas, have previously been developed for practical use. These conventional tips allow for resistance or capacitance measurements, for example, in industrial and commercial applications. However, these conventional tips are typically made out of optically opaque materials, and are generally not considered to be, or have, optically “see-through” features, portions, or regions.

As such, efforts have been made to improve pipette tips, and to improve the systems and methods using the pipette tips. Yet, challenges remain in developing pipette tips and related systems and methods of using the same, that mitigate the deficiencies in the prior art. Therefore, there is a need for improved pipette tips, and for improved systems and methods for using the pipette tips.

### SUMMARY

In some aspects, the techniques described herein relate to a pipette tip, including: a molded body made from an electrically insulating material, the molded body including: an outer surface, an inner surface, and a translucent or transparent feature for seeing through the outer surface and the inner surface; and at least one impedance or capacitance electrode, made from an electrically conductive material, disposed on the outer surface, away from the translucent or transparent feature; wherein each electrode is electrically isolated on the outer surface.

In some aspects, the techniques described herein relate to a pipetting system, including: a liquid handling apparatus, including: a pipette tip attachment point including an electrical contact; a pipette tip, including: a molded body made from an electrically insulating material, the molded body including: an outer surface, an inner surface, and a translucent or transparent feature for seeing through the outer surface and the inner surface; at least one impedance or capacitance electrode, made from an electrically conductive material, disposed on the outer surface, away from the translucent or transparent feature, and an electrical contact corresponding to, and in electrical engagement with, the electrical contact of the pipette tip attachment point; and a controller in communication with the at least one impedance or capacitance electrode, through the electrical engagement, wherein the controller is configured to operate as an impedance sensing device and as a precision capacitance sensing device.

In some aspects, the techniques described herein relate to a pipetting system, including: a plurality of liquid handling apparatus, each liquid handling apparatus of the plurality including: a pipette tip attachment point including an electrical contact; a pipette tip, including: an injection-molded body made from an electrically insulating material, the injection-molded body including: an outer surface, an inner surface, and a translucent or transparent feature for seeing through the outer surface and the inner surface; an extrusion or deposit of electrically conductive, opaque material on the outer surface of the injection-molded body configured as an impedance or capacitance electrode, and an electrical contact corresponding to, and in electrical engagement with, the electrical contact of the pipette tip attachment point; and a controller in communication with the extrusion or deposit of electrically conductive, opaque material, through the electrical engagement of the electrical contacts, wherein the controller is configured to operate as an impedance sensing device and as a precision capacitance sensing device.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 is a perspective view of an illustration of an example pipette tip according to the present disclosure.

FIG. 2 is a perspective view of an illustration of an example pipette tip according to the present disclosure.

FIG. 3 is a perspective view of an illustration of an example pipette tip according to the present disclosure.

FIG. 4 is a side view of an illustration of an example pipetting system having a mechanized liquid handling apparatus or device for utilizing a pipette tip, according to the present disclosure.

FIG. 5A is a front, cut-away view of an illustration of an example pipetting system having a plurality of mechanized liquid handling apparatus, each for utilizing a pipette tip, according to the present disclosure.

FIG. 5B is a magnified view of an illustration of an example pipette tip of one of the liquid handling apparatus of the pipette system of FIG. 5A.

FIG. 6 is a block diagram illustration of an example pipetting system for impedance measurements and capacitance measurements, according to the present disclosure.

FIG. 7 is a block diagram illustration of an example pipetting system for capacitance measurements, according to the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Example Use Case Scenario

The pipette tips according to the present disclosure allow for impedance and/or capacitance measurements, and allow for visual verification of function, and the systems and methods for using the same present a novel approach, and one or more technical steps and/or solutions, to addressing the challenges and deficiencies in the prior art.

For example, in one aspect, the pipette tips and the related systems and methods according to the present disclosure allow for an at least partially electrically conductive pipette tip that also is at least partially optically “see-through”, and for systems and methods of using the same.

In another aspect, systems and methods according to the present disclosure leverage pipette tips having features, portions, or regions that are optically see-through.

In another aspect, systems and methods according to the present disclosure leverage pipette tips having features, portions, or regions that are translucent or essentially translucent or substantially translucent, whereby a user may directly observe any liquid or substance inside the pipette tip during a pipetting operations(s).

In another aspect, systems and methods according to the present disclosure leverage pipette tips having features, portions, or regions that are transparent or essentially transparent or substantially transparent, whereby a user may directly observe any liquid or substance inside the pipette tip during a pipetting operations.

In another aspect, systems and methods according to the present disclosure leverage pipette tips that allow for two (2) or more measurement modalities (or sensing modalities) applicable to a broad range of liquids or substances, and to various practical implementations.

In another aspect, systems and methods according to the present disclosure leverage pipette tips that allow for reliable repeated transfers of certain types of liquids or substances, i.e., those liquids or substances that are not electrically conductive or those that would tend to form an electrically conductive film (e.g., protein solutions).

In another aspect, systems and methods according to the present disclosure leverage pipette tips that allow for impedance measurements and capacitance measurements (as well as resistance measurements, if that terminology is preferred).

In another aspect, systems and methods according to the present disclosure leverage pipette tips that allow for detecting the surface of a liquid or substance using capacitance, i.e., capacitive surface detection.

In another aspect, systems and methods according to the present disclosure leverage pipette tips that allow for detecting and/or tracking the surface of a liquid or substance using impedance.

In another aspect, systems and methods according to the present disclosure leverage pipette tips that allow for detecting and/or tracking the surface of a liquid or substance using impedance and/or capacitance.

In another aspect, systems and methods according to the present disclosure leverage pipette tips that allow for automatically maintaining pipette tip depth in a liquid or substance during a transfer operation.

In another aspect, systems and methods according to the present disclosure leverage pipette tips that allow for tracking liquid levels or substance levels using real-time sensor feedback.

In another aspect, systems and methods according to the present disclosure leverage automatic tracking of a liquid level in real time during a pipetting operation without prior knowledge of the container geometry.

In another aspect, systems and methods according to the present disclosure leverage maintaining a depth of a pipette tip in a liquid throughout a pipetting operation, as the liquid surface rises or falls in its container, without any prior knowledge of the container geometry.

In another aspect, systems and methods according to the present disclosure leverage maintaining a depth of a pipette tip in a liquid throughout a pipetting operation, to avoid cavitation of the liquid at the opening of the pipette tip, and therefore avoiding air from being aspirated.

In another aspect, systems and methods according to the present disclosure leverage maintaining a depth of a pipette tip in a liquid throughout a pipetting operation, to avoid a quantity of liquid from clinging to the pipette tip as it is retracted from the liquid.

In another aspect, systems and methods according to the present disclosure leverage maintaining a depth of a pipette tip in a liquid throughout a pipetting operation, to avoid increased hydrostatic pressure at the opening of the pipette tip, which may cause variations in a resulting pipetted volume.

In another aspect, systems and methods according to the present disclosure leverage maintaining a depth of a pipette tip in a liquid throughout a pipetting operation, even as the liquid level is changing while liquid is being aspirated from or dispensed into a container.

In another aspect, systems and methods according to the present disclosure leverage maintaining a depth of a pipette tip in a liquid throughout a pipetting operation, such that the depth is consistent from one operation to the next.

In another aspect, systems and methods according to the present disclosure leverage automated liquid handling instruments including robots used to transfer specific quantities of liquids or substances between designated containers.

In another aspect, systems and methods according to the present disclosure leverage a wide variety of labware containers typically used in liquid handling applications, including Microtiter® plates and the like containing an array of 96, 384, or 1536 sample wells, as well as larger containers, ranging from vials holding one to two milliliters of liquid, up to large tubes holding tens of milliliters or bottles holding hundreds of milliliters.

In another aspect, systems and methods according to the present disclosure leverage a single electrode, a pair of electrodes, or a plurality of electrodes positioned along a length of the pipette tip.

In another aspect, systems and methods according to the present disclosure leverage a single electrode, a pair of electrodes, or a plurality of electrodes that provide(s) electrical feedback (i.e., an impedance/resistance measurement or a capacitance measurement).

In another aspect, systems and methods according to the present disclosure leverage a single electrode, a pair of electrodes, or a plurality of electrodes each having a securing end with an opening, a fluid transferring end with an opening, an outer surface, and an inner surface, wherein the outer surface includes an electrically insulating material.

In another aspect, systems and methods according to the present disclosure leverage a single electrode, a pair of electrodes, or a plurality of electrodes that extend(s) along a full longitudinal length of the pipette tip from the securing end to the fluid transferring end, or extend along a distance less than the full longitudinal length of the body from the fluid transferring end to the apparatus securing end.

In another aspect, systems and methods according to the present disclosure leverage a single electrode, a pair of electrodes, or a plurality of electrodes each terminating at an electrical point (i.e., an electrical contact or an electrical contact tab) on or near the securing end, wherein the electrical point is where an electrode is electrically connected to the controller.

In another aspect, systems and methods according to the present disclosure leverage a single electrode, a pair of electrodes, or a plurality of electrodes each terminating at an electrical point near the fluid transferring end, where conductive liquid can reach.

In another aspect, systems and methods according to the present disclosure leverage a single electrical contact, a pair of electrical contacts, or a plurality of electrical contacts, each connected to the controller and/or to each other via an electrical strip or wire.

In another aspect, systems and methods according to the present disclosure leverage a single electrical contact, a pair of electrical contacts, or a plurality of electrical contacts, each positioned to extend to the securing end, or to extend beyond the apparatus securing end of the pipette tip.

In another aspect, systems and methods according to the present disclosure leverage pipette tips that allow for capacitance to be measured by one electrode or between two electrodes, and/or for electrical impedance to be measured by two or more electrodes.

In another aspect, systems and methods according to the present disclosure leverage pipette tips configured to have one electrode and a ground, and configured for capacitance measurements.

In another aspect, systems and methods according to the present disclosure leverage pipette tips that allow for automated liquid handling.

In another aspect, systems and methods according to the present disclosure leverage a sensing mechanism on the pipette tip to track the surface of a liquid with respect to the pipette tip during a pipetting operation on an automated liquid handling instrument.

In another aspect, systems and methods according to the present disclosure leverage an automated liquid handling instrument configured to control the depth to which a pipette tip is submerged under the surface of a liquid or substance throughout operation.

In another aspect, system and methods according to the present disclosure leverage a machine vision system, or an optical system, enabling automatic tip detection and labware-presence detection capabilities, and liquid aspiration (into the tip) verification (i.e., prior to each run, the camera scans the tips to see if liquid has been aspirated into the tips, and/or after each run, the camera scans the tips to see if liquid remains in the tips).

### II. Systems and Methods

In one aspect, the present disclosure provides a device, system, and method for pipetting applications

In one aspect, the present disclosure provides a pipetting device or system for automatically maintaining a pipette tip depth in a liquid or substance during a fluid transfer operation.

In one aspect, the present disclosure provides a pipetting system or assembly having: a pipette tip having one or more electrodes according to the present disclosure; a frame supporting an actuator that is operatively connected to the pipette tip, wherein the pipette tip is vertically oriented relative to the frame, and wherein the actuator is adapted to adjust a position of the pipette tip relative to the frame; a controller that is in electrical connection with the one or more electrodes, wherein the electrodes are adapter to send the controller a signal relative to a conductive liquid that comes in contact with the outer surface of the pipette tip; and wherein the controller is adapted to command the actuator to move the position of the pipette tip in response to the signal.

In one aspect, the present disclosure provides a pipette tip having: a securing end with an opening; a fluid transferring end with an opening (e.g., a fluid transferring opening); an outer surface; and an inner surface; wherein the outer surface includes an electrically insulating material; one or more electrode on the outer surface of the pipette tip.

In one aspect, the present disclosure provides a pipette tip having electrically insulating material for the body (such as polypropylene or polyethylene) and an electrically conductive polymer (such as polypropylene or polyethylene impregnated with carbon black or graphene).

In one aspect, the present disclosure provides a pipette tip that is disposable to avoid contamination from one process to another.

In one aspect, the present disclosure provides a pipette tip that is resistant to a wide range of chemicals.

In one aspect, the present disclosure provides a pipette tip that is an injection-molded body product composed of polypropylene.

In one aspect, the present disclosure provides a pipette tip made from any material not inconsistent with the objectives stated herein, for example, a pipette tip made from polyethylene, polybutylene, or other polyolefins.

In one aspect, the present disclosure provides a pipette tip having: an outer surface; an inner surface; and a translucent or transparent feature for seeing through the outer surface and the inner surface; and an impedance or capacitance electrode disposed on the outer surface, away from translucent or transparent feature; wherein the impedance or capacitance electrode is electrically isolated on the outer surface.

In one aspect, the present disclosure provides a pipette tip having: a body having: an outer surface, an inner surface, and a translucent or transparent feature for seeing through the outer surface and the inner surface; and at least one impedance or capacitance electrode, made from an electrically conductive material, disposed on the outer surface, away from the translucent or transparent feature; wherein each electrode is electrically isolated on the outer surface.

In one aspect, the present disclosure provides a pipette tip having a molded body made from an electrically insulating material, the molded body having: an outer surface, an inner surface, and a translucent or transparent portion for seeing through the outer surface and the inner surface; and at least one impedance or capacitance electrode, made from an electrically conductive material, disposed on the outer surface, away from the translucent or transparent portion; wherein each electrode is electrically isolated on the outer surface.

In one aspect, the present disclosure provides a pipette tip, having: a molded body made from an electrically insulating material, the molded body having: an outer surface, and an inner surface, and a translucent portion or a transparent feature for seeing through the outer surface and the inner surface; and at least one extrusion or deposit of electrically conductive material defining an impedance or capacitance electrode on the outer surface; wherein the translucent or the transparent feature is disposed between electrodes.

In one aspect, the present disclosure provides a pipette tip having: an optically translucent body made from an electrically insulating material, the optically translucent body having: an outer surface, and an inner surface; a pair of extrusions or deposits of electrically conductive, opaque material each defining an impedance or capacitance electrode on the outer surface; wherein a translucent portion, or a transparent feature, is disposed between electrodes.

In one aspect, the present disclosure provides a pipette tip having: an optically translucent body made from an electrically insulating material, the optically translucent body having: an outer surface, and an inner surface; an extrusion or a deposit of electrically conductive, opaque material defining an impedance or capacitance electrode on the outer surface.

In one aspect, the present disclosure provides a pipette tip, having: a molded, optically translucent body made from an electrically insulating material, the molded, optically translucent body having: an outer surface, and an inner surface; an extrusion or a deposit of electrically conductive, opaque material defining at least one impedance or capacitance electrode on the outer surface; wherein the electrodes are separated by the electrically insulating material.

In one aspect, the present disclosure provides a pipette tip, having: an injection-molded, optically translucent body made from an electrically insulating material, the injection-molded, optically translucent body having: an outer surface, and an inner surface; an extrusion or a deposit of electrically conductive, opaque material defining an impedance or capacitance electrode on the outer surface of the injection-molded, optically translucent body.

In one aspect, the present disclosure provides a method for automatically maintaining a pipette tip depth in a conductive liquid during a fluid transfer operation including: providing a pipetting device having a pipette tip; providing a container fixed in height relative to the frame, the container holding a conductive liquid having a first liquid level; positioning the pipette tip in the container such that at least a portion of the electrode(s) are submerged in the conductive liquid, wherein the positioning step forms a control loop between the electrode(s), the actuator, the controller, and the conductive liquid; measuring by the controller impedance and/or capacitance using the electrode(s); sending by the controller a control signal to the actuator, wherein the controller is configured to command the actuator to move the pipette tip vertically in response to the signal.

In one aspect, the present disclosure provides a method including: aspirating by the pipette tip an amount of the conductive liquid, wherein the conductive liquid has a second liquid level following the aspirating step; and commanding by the controller the actuator to move the pipette tip relative to the second liquid level such that the first and second electrodes remain submerged in the conductive liquid.

In one aspect, the present disclosure provides a method including: dispensing by the pipette tip an amount of the conductive liquid, wherein the conductive liquid has a second liquid level following the dispensing step; and commanding by the controller the actuator to move the pipette tip relative to the second liquid level such that the first and second electrodes remain submerged in the conductive liquid.

In one aspect, the present disclosure provides a method including: maintaining by the control loop the pipette tip at a constant second liquid level relative to the liquid surface of the conductive liquid.

In one aspect, the present disclosure provides a dual shot injection molding method comprising a first shot of transparent insulating polypropylene material to form the body and inner cone of the pipette tip, and a second shot of electrically conductive polypropylene to form the separate conductive electrodes, resulting in a single part or unit composed of two different materials (polypropylene can be made to be electrically conductive through the addition of a variety of conductive additives, such as conductive carbon black or various inorganic conductors known to those in the art; accordingly, polypropylene is an appropriate material for the second shot to form the two separate conductive pipette tip electrodes).

In one aspect, the present disclosure provides a method for selectively coating the outside of a pipette tip with a conductive material, including: printing a conductive ink or applying a conductive resin, among other techniques to the body of the pipette tip (which itself is composed of electrically insulating polypropylene and is produced by an injection molding process); applying conductive electrodes to the pipette tip in a secondary process, in which conductive polypropylene is printed onto the outside of the pipette tip to form thin conductive strips (one advantage of such a method is that the conductive strips can cover a very small area of the outside of the pipette tip, leaving much of the pipette tip transparent to an observer, such that a user or machine vision system can directly observe any liquid inside the pipette tip during a pipetting operation.

In one aspect, the present disclosure provides a pipetting system or assembly having a mechanized liquid handling apparatus or device, for utilizing a pipette tip, and for methods described herein, and having a pump in fluidic communication with the pipette tip, via an enclosed fluid conduit or channel filled with a volume of system fluid (e.g., air), and having a frame supporting a linear actuator that adjusts the height of the liquid handling apparatus in order to insert the pipette tip into a liquid.

In one aspect, the present disclosure provides a liquid handling apparatus that is fixed to a vertically oriented linear actuator, or wherein the linear actuator can be fixed in other orientations, such as obliquely or diagonally to the fixed frame.

In one aspect, the present disclosure provides a liquid handling apparatus having a pipette tip attachment point including electrical contact points to conduct electrical signals between the pipette tip electrical contacts and wires leading to an electronic controller.

In one aspect, the present disclosure provides a liquid handling apparatus wherein the height of the liquid handling apparatus is adjusted by the electronic controller (i.e., a microcontroller capable of, but not limited to, generating and receiving signals, processing the signals, sending motion commands, and processing data in order to perform the electronic functions described herein as well as other features), via the linear actuator, in order to keep the opening of the pipette tip submerged in the liquid at a consistent depth as the liquid level changes.

In one aspect, the present disclosure provides a liquid handling apparatus wherein the height of the liquid handling apparatus is adjusted by the electronic controller (i.e., a microcontroller capable of, but not limited to, generating and receiving signals, processing the signals, sending motion commands, and processing data in order to perform the electronic functions described herein as well as other features), via the linear actuator, such that the opening of the pipette tip remains at a consistent depth below the liquid surface as the liquid level changes.

### III. With Reference to the Figures

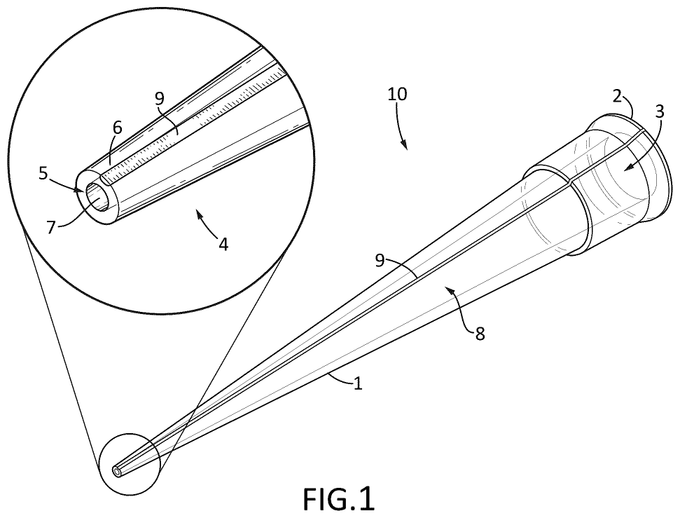

FIG. 1 is a perspective view of an illustration of an example pipette tip according to the present disclosure. In particular, in one aspect, the pipette tip 10 has a molded body 1 made from an electrically insulating material, the molded body having: a securing end 2 with an opening 3; a fluid transferring end 4 with a fluid transferring opening 5; an outer surface 6; an inner surface 7; a translucent or transparent portion 8 for seeing through the outer surface 6 and the inner surface 7; and at least one impedance or capacitance electrode 9, made from an electrically conductive and opaque material, disposed on the outer surface 6, wherein each electrode is electrically isolated on the outer surface.

In another aspect, as illustrated in FIG. 1, the impedance or capacitance electrode 9 of the pipette tip 10 is an extrusion or deposit of electrically conductive, opaque material defining the impedance or capacitance electrode 9 on the outer surface 6; wherein the translucent or transparent portion 8 is disposed between electrodes.

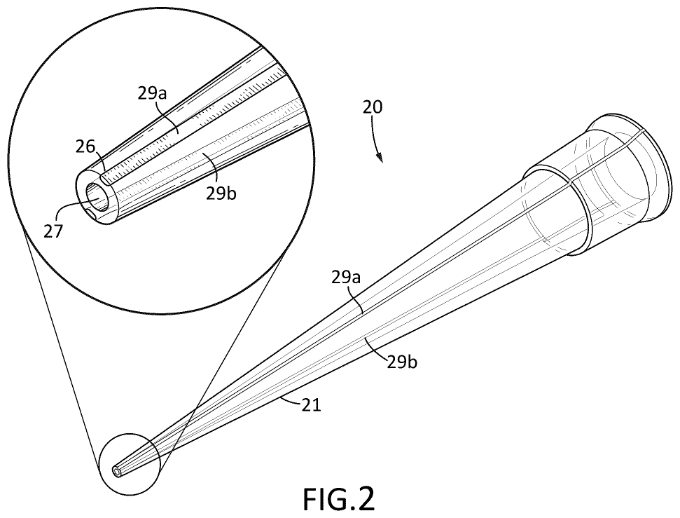

Turning now to FIG. 2, FIG. 2 is a perspective view of an illustration of an example pipette tip according to the present disclosure. In particular, in one aspect, the pipette tip 20 has an optically translucent body 21 made from an electrically insulating material, the optically translucent body 21 having: an outer surface 26, and an inner surface 27; a pair of extrusions or deposits of electrically conductive, opaque material each defining an impedance or capacitance electrode 29a, 29b on the outer surface 26.

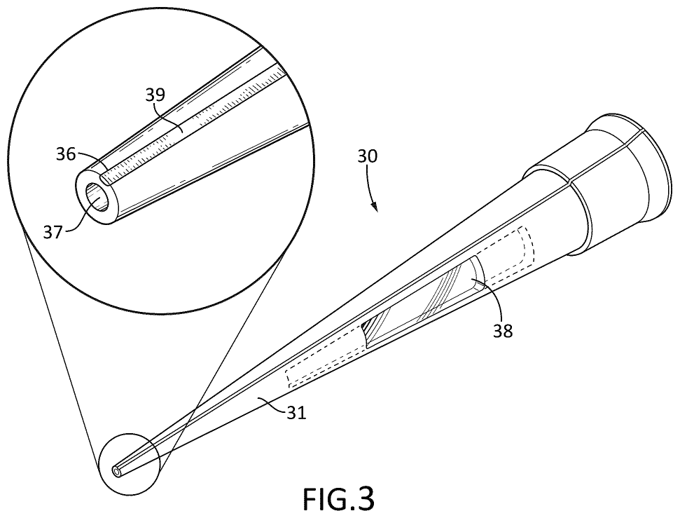

Turning now to FIG. 3, FIG. 3 is a perspective view of an illustration of an example pipette tip according to the present disclosure. In particular, in one aspect, the pipette tip 30 has a body 31 having an outer surface 36, an inner surface 37, and a translucent or transparent feature 38 for seeing through the outer surface 36 and the inner surface 37; and at least one impedance or capacitance electrode 39, made from an electrically conductive material, disposed on the outer surface 36, away from the translucent or transparent feature 38; wherein each electrode 39 is electrically isolated on the outer surface.

In another aspect, as illustrated in FIG. 3, the translucent or transparent feature 38 of the pipette tip 30 may be configured as a window-type or gallery-type feature, or configured to have different dimensions and positions along the body 31.

As such, in another aspect, as illustrated in FIG. 3, the translucent or transparent feature 38 of the pipette tip 30 has a molded body 31 made from an electrically insulating material, the molded body 31 has the outer surface 36, the inner surface 37, and the translucent portion or the transparent feature 38 for seeing through the outer surface 36 and the inner surface 37; and at least one extrusion or deposit of electrically conductive material defining an impedance or capacitance electrode 39 on the outer surface 36; wherein the translucent or the transparent feature 38 is situated away from the electrode 39/disposed between electrodes 39.

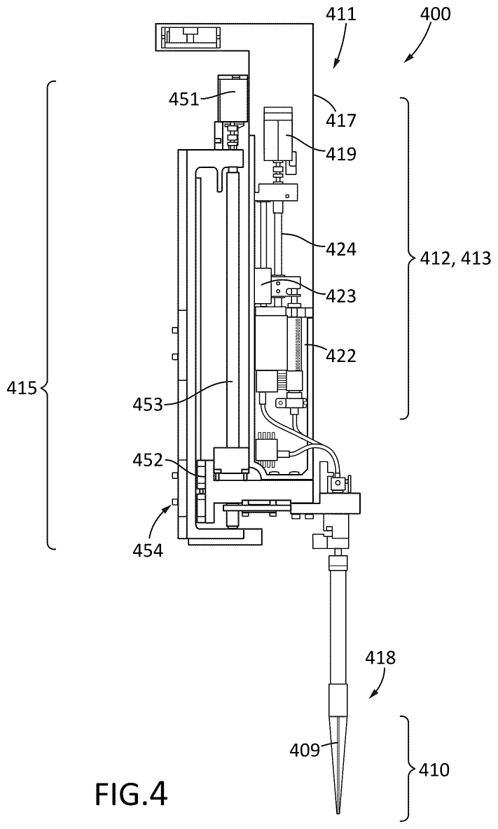

Turning now to FIG. 4, FIG. 4 is a side view of an illustration of an example pipetting system having a mechanized liquid handling apparatus or device for utilizing a pipette tip, according to the present disclosure. In particular, in one aspect, the pipetting system 400 includes a liquid handling apparatus 411 with a pipette tip 410 in airtight connection to a conduit 418 leading to the pump 412, and an electronic controller 417 governing the pipetting system 400 in electrical connection with the pipette tip electrode 409 and a vertical linear actuator 415, which can move the liquid handling apparatus 411 vertically. In another aspect, the pump 412 can be any mechanism that provides positive or negative pressure, such as a syringe pump 413, wherein the syringe pump 413 can include, but is not limited to, a motor 419, a syringe 422, a linear motion guide 423, and a lead screw 424. Moreover, in another aspect, the vertical linear actuator 415 can include, but is not limited to, a motor 451, a linear motion guide 452, a lead screw 453, and an attachment to the fixed frame 454 of the pipetting system 400.

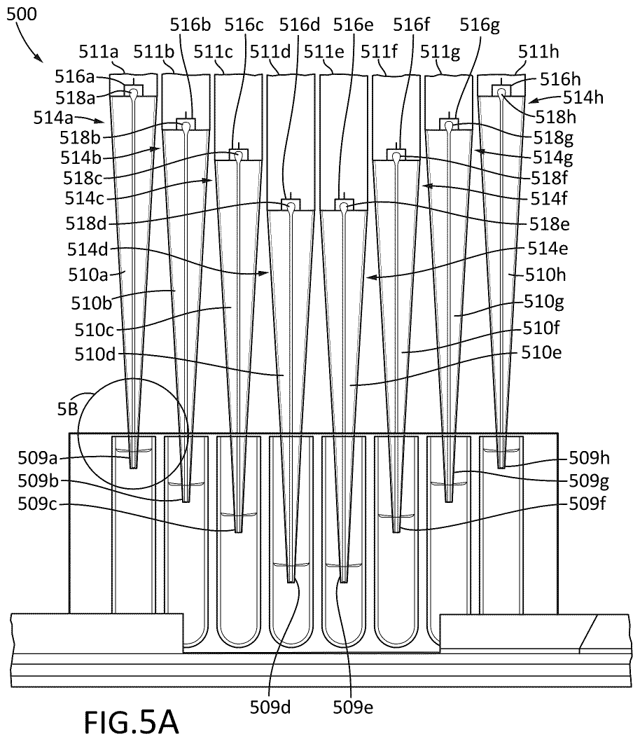

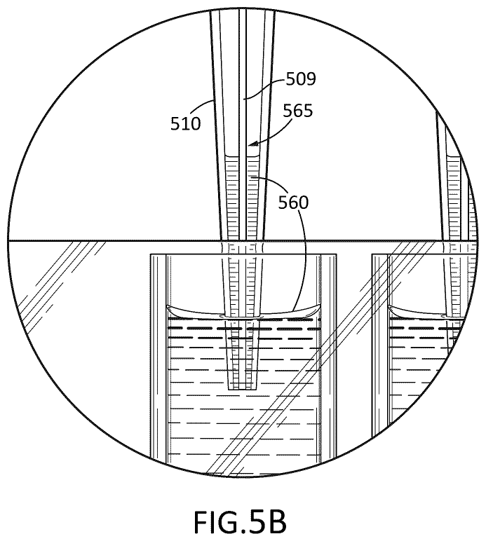

Turning now to FIGS. 5A and 5B, FIG. 5A is a front, cut-away view of an illustration of an example pipetting system having a plurality of mechanized liquid handling apparatus, each for utilizing a pipette tip, according to the present disclosure; and FIG. 5B is a magnified view of an illustration of an example pipette tip of one of the liquid handling apparatus of the pipette system of FIG. 5A. In particular, in one aspect, as illustrated in FIG. 5A, the pipette system 500 includes eight (8) individual, side-by-side, independently-controlled liquid handling apparatus 511a-511h, each having its own pipette tip 510, each with at least one impedance or capacitance electrode 509 (i.e., a single electrode that can take a capacitance measurement by itself, and the same electrode that can take an impedance measurement with another electrode). In another aspect, each liquid handling apparatus 511a-511h has its own pipette tip attachment point 514 each with an electrical contact(s) 516; each electrical contact 516 corresponding to the electrical contact 518 of the respective pipette tip 510. In this way, in another aspect, during and after pipette tip 510 attachment to the respective liquid handling apparatus 511, the electrical contact 516 of the pipette tip attachment point 514 touches the electrical contact 518 of the pipette tip 510 such that an electrical signal can be transmitted therethrough. Moreover, in another aspect, the electrical contacts 516, 518 come into good electrical engagement such that a capacitance measurement can be taken via the corresponding impedance or capacitance electrode 509, or such that an impedance (or resistance) measurement can be taken using any two impedance or capacitance electrodes (for example, using the corresponding impedance or capacitance electrode 509 along with any other impedance or capacitance electrode of the same pipette tip 510).

In another aspect, as illustrated in FIG. 5B, during pipetting or fluid transfer operations or runs, the pipette tip 510 may be inserted into a liquid 560 and the liquid 560 may be aspirated or drawn into the pipette tip 510, which is a pipette tip similar to that illustrated in FIG. 1, and which has an optically translucent body made from an electrically insulating material, and which has an extrusion or a deposit 565 of electrically conductive, opaque material defining the impedance or capacitance electrode 509. As such, in another aspect, the pipette tip 510 allows for impedance and/or capacitance measurements, and allows for visual verification that the liquid 560 was aspirated or drawn into the pipette tip 510 (i.e., visual verification of function). Moreover, in another aspect, the pipette tip 510 allows for a user (not illustrated), or any machine vision system directed at the pipette tip 510 (not illustrated), for example, to directly observe the liquid 560 inside the pipette tip 510 during an operation or run.

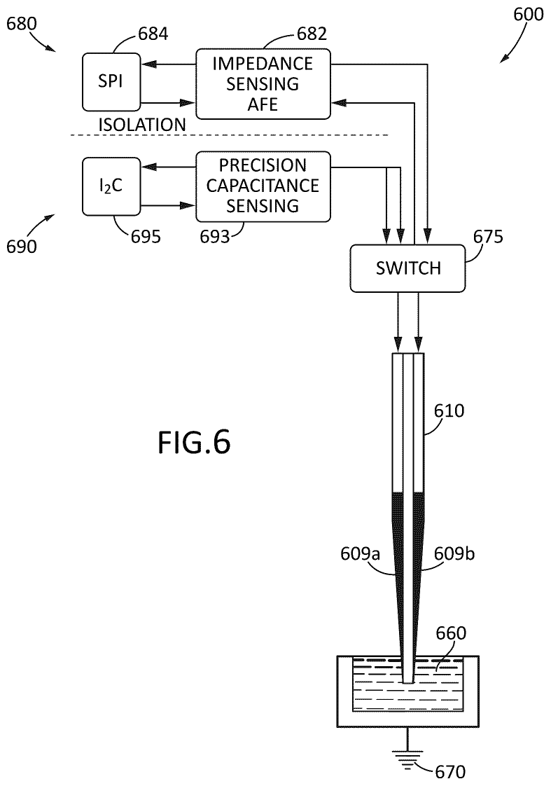

Turning now to FIG. 6, FIG. 6 is a block diagram illustration of an example pipetting system for impedance measurements and capacitance measurements, according to the present disclosure. In particular, in one aspect, the pipetting system 600 includes a pipette tip 610 having a first impedance or capacitance electrode 609a and a second impedance or capacitance electrode 609b inserted into a liquid 660 such that the liquid 660 may be aspirated or drawn into the pipette tip 610. In another aspect, when inserted into the liquid 660, the first impedance or capacitance electrode 609a and the second impedance or capacitance electrode 609b may be in electrical communication with each other and with a ground 670. Moreover, in another aspect, the first impedance or capacitance electrode 609a and the second impedance or capacitance electrode 609b are connected to a switch 675. Furthermore, in another aspect, the switch 675 is configured to control the connection path to the first impedance or capacitance electrode 609a and/or to the second impedance or capacitance electrode 609b, from an isolated impedance sensing circuit or electronic device 680 or from a precision capacitance sensing circuit or electronic device 690.

In another aspect, as illustrated in FIG. 6, the impedance sensing circuit or electronic device 680 of the pipetting system 600 includes an impedance sensing power analog front end (AFE) 682 (such as, for example, AD5940/AD5941), that is held in isolation, having voltage, current, and impedance measurement capabilities, and a serial peripheral interface (SPI) 684. In another aspect, the impedance sensing AFE 682 may consist of two high precision excitation loops and one common measurement channel, which enables a wide range of measurements capabilities (the first excitation loop consisting of an ultra-low power, dual-output string, digital-to-analog converter (DAC), and a low power, low noise potentiostat, with one output of the DAC controlling the noninverting input of the potentiostat, and the other output controlling the noninverting input of the transimpedance amplifier (TIA), and capable of generating signals from dc to 200 Hz) (the second excitation loop consisting of a 12-bit DAC, referred to as the high speed DAC capable of generating high frequency excitation signals up to 200 kHz). In another aspect, the impedance sensing AFE 682 also is configured for serial peripheral interface input/output for communicating with the SPI 684.

In another aspect, as illustrated in FIG. 6, the precision capacitance sensing circuit or electronic device 690 of the pipetting system 600 includes a capacitance-to-digital converter 693 (such as, for example, FDC1004), for implementing capacitive sensing solutions, and an inter-integrated circuit (I2C) 695. In another aspect, the capacitance-to-digital converter 693 may be a high-resolution, 4-channel converter wherein each channel has a full scale range of ±15 pF and can handle a sensor offset capacitance of up to 100 pF, which can be either programmed internally or can be an external capacitor for tracking environmental changes over time and temperature. In another aspect, the capacitance-to-digital converter 693 also may include shield drivers for sensor shields, which can reduce EMI interference and help focus the sensing direction of a capacitive sensor. Moreover, in another aspect, the capacitance-to-digital converter 693 may capable of single ended measurement (for interfacing to a single-ended capacitive sensor) and capable of differential measurement (for interfacing to a differential capacitive sensor). Furthermore, in another aspect, the capacitance-to-digital converter 693 also is configured for inter-integrated circuit communication protocols for communicating with the I2C 695.

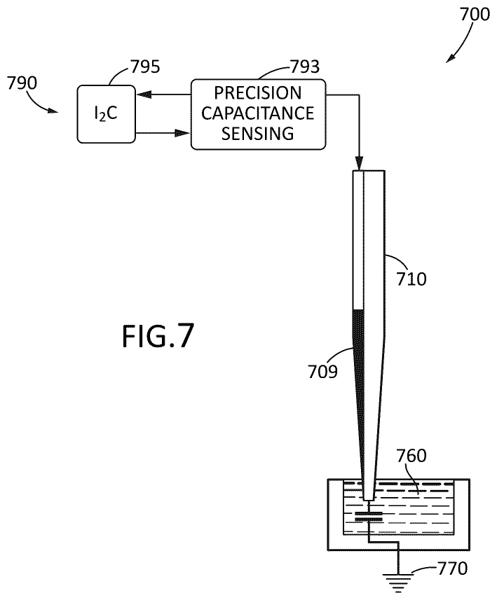

Turning now to FIG. 7, FIG. 7 is a block diagram illustration of an example pipetting system for capacitance measurements, according to the present disclosure. In particular, in one aspect, the pipetting system 700 includes a pipette tip 710 having a capacitance electrode 709 inserted into a liquid 760 such that the liquid 760 may be aspirated or drawn into the pipette tip 710. In another aspect, when inserted into the liquid 760, the capacitance electrode 709 may be in electrical communication with a ground path 770. Moreover, in another aspect, the capacitance electrode 709 is connected to a precision capacitance sensing circuit or electronic device 790. Furthermore, in another aspect, the precision capacitance sensing circuit or electronic device 790 of the pipetting system 700 includes a capacitance-to-digital converter 793 (such as, for example, FDC1004), for implementing capacitive sensing solutions, and an inter-integrated circuit (I2C) 795.

### IV. Embodiments

Certain implementations of systems and methods consistent with the present disclosure are provided as claim clauses.

Clause 1. A pipette tip, comprising: a molded body made from an electrically insulating material, the molded body comprising: an outer surface, an inner surface, and a translucent or transparent feature for seeing through the outer surface and the inner surface; and at least one impedance or capacitance electrode, made from an electrically conductive material, disposed on the outer surface, away from the translucent or transparent feature; wherein each electrode is electrically isolated on the outer surface.

Clause 2. The pipette tip of clause 1, wherein the at least one impedance or capacitance electrode includes a pair of impedance or capacitance electrodes.

Clause 3. The pipette tip of clause 2, wherein the translucent or transparent feature is disposed between the pair of impedance or capacitance electrodes.

Clause 4. The pipette tip of clause 3, wherein the pair of impedance or capacitance electrodes are a pair of extrusions or deposits of electrically conductive, opaque material, each defining an impedance or capacitance electrode disposed on the outer surface of the molded body.

Clause 5. The pipette tip of clause 1, wherein the molded body is optically translucent or optically transparent.

Clause 6. The pipette tip of clause 5, wherein the translucent or transparent feature is a translucent or transparent portion of the molded body.

Clause 7. The pipette tip of clause 1, wherein the molded body is an injection-molded, optically translucent or transparent body made from the electrically insulating material.

Clause 8. The pipette tip of clause 7, wherein the at least one impedance or capacitance electrode is an extrusion or deposit of electrically conductive, opaque material on the outer surface of the injection-molded, optically translucent or transparent body.

Clause 9. A pipetting system, comprising: a liquid handling apparatus, comprising: a pipette tip attachment point comprising an electrical contact; a pipette tip, comprising: a molded body made from an electrically insulating material, the molded body comprising: an outer surface, an inner surface, and a translucent or transparent feature for seeing through the outer surface and the inner surface; at least one impedance or capacitance electrode, made from an electrically conductive material, disposed on the outer surface, away from the translucent or transparent feature, and an electrical contact corresponding to, and in electrical engagement with, the electrical contact of the pipette tip attachment point; and a controller in communication with the at least one impedance or capacitance electrode, through the electrical engagement, wherein the controller is configured to operate as an impedance sensing device and as a precision capacitance sensing device.

Clause 10. The pipetting system of clause 9, wherein the at least one impedance or capacitance electrode includes a pair of impedance or capacitance electrodes.

Clause 11. The pipetting system of clause 10, wherein the translucent or transparent feature is disposed between the pair of impedance or capacitance electrodes.

Clause 12. The pipetting system of clause 11, wherein the pair of impedance or capacitance electrodes are a pair of extrusions or deposits of electrically conductive, opaque material, each defining an impedance or capacitance electrode disposed on the outer surface of the molded body.

Clause 13. The pipetting system of clause 9, wherein the molded body is optically translucent or optically transparent.

Clause 14. The pipetting system of clause 13, wherein the translucent or transparent feature is a translucent or transparent portion of the molded body.

Clause 15. The pipetting system of clause 9, wherein the molded body is an injection-molded, optically translucent or transparent body made from the electrically insulating material.

Clause 16. The pipetting system of clause 15, wherein the at least one impedance or capacitance electrode is an extrusion or deposit of electrically conductive, opaque material on the outer surface of the injection-molded, optically translucent or transparent body.

Clause 17. A pipetting system, comprising: a plurality of liquid handling apparatus, each liquid handling apparatus of the plurality comprising: a pipette tip attachment point comprising an electrical contact; a pipette tip, comprising: an injection-molded body made from an electrically insulating material, the injection-molded body comprising: an outer surface, an inner surface, and a translucent or transparent feature for seeing through the outer surface and the inner surface; an extrusion or deposit of electrically conductive, opaque material on the outer surface of the injection-molded body configured as an impedance or capacitance electrode, and an electrical contact corresponding to, and in electrical engagement with, the electrical contact of the pipette tip attachment point; and a controller in communication with the extrusion or deposit of electrically conductive, opaque material, through the electrical engagement of the electrical contacts, wherein the controller is configured to operate as an impedance sensing device and as a precision capacitance sensing device.

Clause 18. The pipetting system of clause 17, wherein the injection-molded body is optically translucent or optically transparent.

Clause 19. The pipetting system of clause 18, wherein the translucent or transparent feature is a translucent or transparent portion of the injection-molded body.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A pipette tip, comprising:
a molded body made from an electrically insulating material, the molded body comprising:
an outer surface,
an inner surface, and
a translucent or transparent feature for seeing through the outer surface and the inner surface; and
at least one impedance or capacitance electrode, made from an electrically conductive material, disposed on the outer surface, away from the translucent or transparent feature;
wherein each electrode is electrically isolated on the outer surface.

2. The pipette tip of claim 1, wherein the at least one impedance or capacitance electrode includes a pair of impedance or capacitance electrodes.

3. The pipette tip of claim 2, wherein the translucent or transparent feature is disposed between the pair of impedance or capacitance electrodes.

4. The pipette tip of claim 3, wherein the pair of impedance or capacitance electrodes are a pair of extrusions or deposits of electrically conductive, opaque material, each defining an impedance or capacitance electrode disposed on the outer surface of the molded body.

5. The pipette tip of claim 1, wherein the molded body is optically translucent or optically transparent.

6. The pipette tip of claim 5, wherein the translucent or transparent feature is a translucent or transparent portion of the molded body.

7. The pipette tip of claim 1, wherein the molded body is an injection-molded, optically translucent or transparent body made from the electrically insulating material.

8. The pipette tip of claim 7, wherein the at least one impedance or capacitance electrode is an extrusion or deposit of electrically conductive, opaque material on the outer surface of the injection-molded, optically translucent or transparent body.

9. A pipetting system, comprising:
a liquid handling apparatus, comprising:
a pipette tip attachment point comprising an electrical contact;
a pipette tip, comprising:
a molded body made from an electrically insulating material, the molded body comprising:
an outer surface,
an inner surface, and
a translucent or transparent feature for seeing through the outer surface and the inner surface;
at least one impedance or capacitance electrode, made from an electrically conductive material, disposed on the outer surface, away from the translucent or transparent feature, and
an electrical contact corresponding to, and in electrical engagement with, the electrical contact of the pipette tip attachment point; and
a controller in communication with the at least one impedance or capacitance electrode, through the electrical engagement, wherein the controller is configured to operate as an impedance sensing device and as a precision capacitance sensing device.

10. The pipetting system of claim 9, wherein the at least one impedance or capacitance electrode includes a pair of impedance or capacitance electrodes.

11. The pipetting system of claim 10, wherein the translucent or transparent feature is disposed between the pair of impedance or capacitance electrodes.

12. The pipetting system of claim 11, wherein the pair of impedance or capacitance electrodes are a pair of extrusions or deposits of electrically conductive, opaque material, each defining an impedance or capacitance electrode disposed on the outer surface of the molded body.

13. The pipetting system of claim 9, wherein the molded body is optically translucent or optically transparent.

14. The pipetting system of claim 13, wherein the translucent or transparent feature is a translucent or transparent portion of the molded body.

15. The pipetting system of claim 9, wherein the molded body is an injection-molded, optically translucent or transparent body made from the electrically insulating material.

16. The pipetting system of claim 15, wherein the at least one impedance or capacitance electrode is an extrusion or deposit of electrically conductive, opaque material on the outer surface of the injection-molded, optically translucent or transparent body.

17. A pipetting system, comprising:
a plurality of liquid handling apparatus, each liquid handling apparatus of the plurality comprising:
a pipette tip attachment point comprising an electrical contact;
a pipette tip, comprising:
an injection-molded body made from an electrically insulating material, the injection-molded body comprising:
an outer surface,
an inner surface, and
a translucent or transparent feature for seeing through the outer surface and the inner surface;
an extrusion or deposit of electrically conductive, opaque material on the outer surface of the injection-molded body configured as an impedance or capacitance electrode, and
an electrical contact corresponding to, and in electrical engagement with, the electrical contact of the pipette tip attachment point; and
a controller in communication with the extrusion or deposit of electrically conductive, opaque material, through the electrical engagement of the electrical contacts, wherein the controller is configured to operate as an impedance sensing device and as a precision capacitance sensing device.

18. The pipetting system of claim 17, wherein the injection-molded body is optically translucent or optically transparent.

19. The pipetting system of claim 18, wherein the translucent or transparent feature is a translucent or transparent portion of the injection-molded body.
